(19) United States
(12) Patent Application Publication
(10) Pub. No.: US 2005/0203833 A1
(43) Pub. Date: Sep. 15, 2005

(54) Methods and systems for financing food expenses with a loan secured by real property

(76) Inventor: John J. Pembroke, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/077,990

(22) Filed: Mar. 11, 2005

Related U.S. Application Data
(63) Continuation-in-part of application No. 11/039,367, filed on Jan. 18, 2005.
Application No. 11/039,367 is a continuation-in-part of application No. 10/219,797, filed on Aug. 14, 2002.

(51) Int. Cl. G06F 17/60

(52) U.S. Cl. 705/38

(57) ABSTRACT

Methods and systems provide a loan to a borrower. An identification of real property and a specification of a monetary amount to be used for future payment of food expenses is received. A total loan value for the real property and the specified monetary amount is calculated. Approval of the loan secured by the real property for the total loan value is requested. A closing is initiated on the loan at which a customer depository account is funded with the specified monetary amount to provide future funds for payment of food expenses incurred by the borrower.

### CROSS-REFERENCES TO RELATED APPLICATIONS

This application is a continuation-in-part of U.S. patent application Ser. No. 10/219,797, entitled “SYSTEM AND METHOD FOR BUNDLING TELECOMMUNICATIONS AND UTILITIES INTO A MORTGAGE,” filed Aug. 14, 2002 by John J. Pembroke, and is a continuation-in-part of U.S. patent application Ser. No. 11/039,367, entitled “METHODS AND SYSTEMS FOR FINANCING EXPENSES WITH A LOAN SECURED BY REAL PROPERTY,” filed Jan. 18, 2005 by John J. Pembroke, the entire disclosure of each of which is incorporated herein by reference for all purposes (“the parent applications”).

This application is related to U.S. patent application Ser. No. 11/039,367, entitled “METHODS AND SYSTEMS FOR FINANCING HEALTHCARE EXPENSES WITH A LOAN SECURED BY REAL PROPERTY” by John J. Pembroke, the entire disclosure of which is incorporated herein by reference for all purposes (“the related application”).

### BACKGROUND OF THE INVENTION

This application relates generally to real-property mortgages. More specifically, this application relates to methods and systems for financing food expenses with a loan secured by real property.

Typical property owners have a number of expenses. A common ordering of their living costs for property owners in order of expense is: their home mortgage payment, healthcare, food, energy, and telecommunications. Of these five principal expenses, only the mortgage payment provides financing over an extended period of time. The other expenses are paid as they are incurred and may be subject to substantial variations as a result of external impacts, such as when world events affect the availability, and therefore the cost, of different groups of food.

It is commonly known that food expenses already form a significant portion of family budgets and are continuing to increase. Currently, the average cost for food for a family is approximately $4300/year, with about $2700 of that spent on food consumed at home and $1600 of that spent on food consumed away from home. Expenses for food amount to about 12% of the typical family budget. In many instances, the high cost of food affects the quality of food that people consume as they seek ways to lower the cost of food so that they may meet other expenses.

There is, thus, a general need in the art for methods and systems that mitigate the effect of these costs.

### BRIEF SUMMARY OF THE INVENTION

Embodiments of the invention provide methods and systems for providing a loan to a borrower. In a first set of embodiments, an identification of real property and a specification of a monetary amount to be used for future payment of food expenses is received. A total loan value for the real property and the specified monetary amount is calculated. Approval of the loan secured by the real property for the total loan value is requested. A closing is initiated on the loan at which a customer depository account is funded with the specified monetary amount to provide future funds for payment of food expenses incurred by the borrower.

In some such embodiments, a set of limitations is received defining food expenses that qualify for payment with funds in the customer depository account. Restrictions on withdrawal of funds from the customer depository account are initiated in accordance with the limitations. For example, the set of limitations may define one or more specific merchants at which food must be purchased to qualify for payment with funds in the customer depository account. As another example, the set of limitations may define that only food purchased from merchants selling food for normal consumption at home qualifies for payment with funds in the customer depository account.

In some instances, issuance of a debit instrument to the customer may be initiated. The debit instrument may be used at a point of sale to debit the customer depository account as part of a debit transaction for payment of the food expenses. Merely by way of example, the debit instrument may comprise a magnetic-stripe card or may comprise a smart card.

Some embodiments may additionally accommodate additional specification of products and/or services distinct from the monetary amount to be used for future payment of food expenses. Calculation of the total loan value comprises calculating the total loan value for the real property, the specified monetary amount, and the additional products and/or services. The customer depository account is funded with the specified monetary amount and a supplementary monetary amount for payment of expenses for the additional products and/or services. In one such embodiment, the customer depository account comprises a plurality of customer depository accounts, each of which is identified with a distinct subset of the products and/or services and the monetary amount to be used for future payment of food expenses; a transfer of funds may be effected among at least some of the plurality of customer depository accounts. In another such embodiment, the customer depository account is segregated for separate tracking of funds identified with distinct subsets of the products and/or services and the monetary amount to be used for future payment of food expenses; an identification of the funds among the distinct subsets may be changed.

In a second set of embodiments, an identification of real property and a specification of products and/or services providing expenses is received. A total loan value for the real property and specified products and/or services is calculated. Approval of the loan secured by the real property for the total loan value is requested. A closing on the loan is initiated at which a customer depository account is funded to provide future funds for payment of the expenses. Issuance of a debit instrument to the customer is initiated, with the debit instrument usable at a point of sale to debit the customer depository account for payment of the expenses.

In some embodiments, the loan may also be secured by the specified products and/or services. In one embodiment, an appraisal of the value of the property with the specified products and/or services is initiated, and a back-end ratio that omits consideration of separate payment of the expenses by the borrower is calculated. Funds in the customer depository account may be designated as a prepaid asset linked with the real property, whereby the funds in the customer depository account comprise a real-property interest. In some embodiments, foreclosure against the real property and against the customer depository account may be initiated in response to a default by the borrower on terms of the loan.

In other embodiments, payment of a guarantee amount defined by a remaining value of the products and/or services may be initiated to a lender of the total loan value in response to a default by the borrower on terms of the loan. Alternatively, a transfer of ownership of the real property and a transfer of obligations under the loan may be initiated to a guarantor in response to a default by the borrower on terms of the loan. In some instances, a transfer of the customer depository account to a new buyer of the real property may be initiated. In other instances, a transfer of the customer depository account to a new property purchased by a current owner of the real property may be initiated after a sale of the real property. Provision may be included for increasing a value of the customer depository account by depositing additional funds after closing into the customer depository account, thereby extending a useable term of the customer depository account for payment of the expenses.

The customer depository account may comprise a plurality of customer depository accounts, each of which is identified with a distinct subset of the products and/or services, so that a transfer of funds among at least some of the plurality of customer depository accounts may be effected. Alternatively, the customer depository account may be segregated for separate tracking of funds identified with distinct subsets of the products and/or services, so that an identification of the funds among the distinct subsets may be changed.

In a third set of embodiments, an identification of real property and a specification of medical and/or healthcare services is received. A total loan value for the real property and specified medical and/or healthcare services is calculated. Approval of the loan secured by the real property for the total loan value is requested. A closing on the loan at which a customer depository account is funded to provide future funds for payment of expenses for the medical and/or healthcare services is initiated. Issuance of a debit instrument to the customer is initiated and may be used to debit the customer depository account for payment of the medical and/or healthcare expenses.

The methods of the present invention may be embodied in a computer-readable storage medium having a computer-readable program embodied therein for directing operation of a computer system. Such a computer system may include a communications system, a processor, and a storage device. The computer-readable program includes instructions for operating the computer system to provide a loan to a borrower in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 provides a schematic illustration of a functional environment in which a bundling company operates in accordance with embodiments of the invention;

FIG. 2 is a flow diagram illustrating a method for financing food expenses with a loan secured by real property in a first embodiment;

FIGS. 3 and 4 are flow diagrams illustrating methods for financing food expenses with a loan secured by real property in other embodiments of the invention;

FIG. 5 is a flow diagram illustrating a method for obtaining an appraisal in concert with the methods of FIGS. 2-4 in some embodiments;

FIG. 6 is a flow diagram illustrating the effect of default on a loan that finances food expenses in accordance with embodiments of the invention;

FIG. 7 is a flow diagram illustrating the use of a debit instrument to purchase food with funds from an account secured by real property; and

FIG. 8 is a schematic block diagram illustrating the structure of a computer system on which methods of the invention may be embodied.

### DETAILED DESCRIPTION OF THE INVENTION

Embodiments of the invention insulate consumers from the effects of food costs by providing a loan secured by real property that may be used to finance food expenses through a food-financing program. In some instances, security for the loan may be provided by the real property and some other property, such as by a cash value of the food-financing program in one embodiment. Some of the food expenses that may be financed include food that is purchased for consumption at home, such as when food is purchased from a grocery store, specialty food store, convenience store, or the like. In other instances, the food expenses arise from the purchase of food for consumption elsewhere, such as in a restaurant or other food-selling venue.

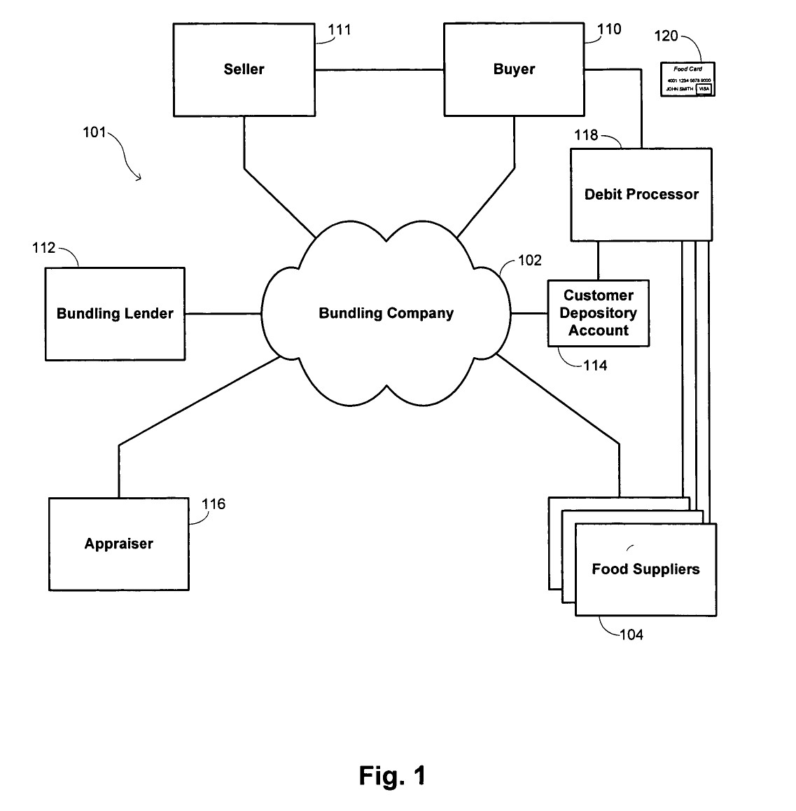

The secured loan is provided in embodiments of the invention by a “bundling lender,” which is any entity that provides a real-estate-secured loan that bundles at least some food expenses as part of a food-financing program. Examples of entities that may be comprised by the bundling lender include mortgage brokers, mortgage bankers, commercial banks, finance companies, credit unions, insurance companies, stock brokerage firms, and individual investors; it is not necessary according to embodiments of the invention that the bundling lender be associated with a financial institution. The bundling of the food expenses is coordinated by a bundling company, which interacts with the bundling lender. An overview of an environment in which the bundling company may operate in structuring the loan is illustrated schematically with the block diagram of FIG. 1, with the environment denoted generally by reference number 101.

The bundling company 102 may comprise any entity that offers bundleable food expenses to be included in a loan and/or that facilitates the marketing or sale of bundleable food expenses. Examples of bundling companies in certain specific embodiments include suppliers of products and services, mortgage bankers, mortgage brokers, real estate agents, real estate brokers, builders, land developers, financial planners, or various facilitators such as independent marketing entities, title companies, insurance companies, appraisers, etc. The bundling company 102 may have relationships with one or more suppliers 104 of food, although more generally embodiments of the invention permit the bundled service to be used for payment of any food expenses as described below. The bundling company 102 may negotiate discounted prices for the food expenses, using its position as an interface to large volumes of such food expenses for many potential customers to obtain very favorable prices. For instance, the bundling company 102 might negotiate with a chain of supermarkets or a chain of restaurants to provide discounts of 5% or 10% on all food costs to customers who bundle food expenses as described herein. Such an arrangement may act as an incentive to attract greater numbers of customers to the supermarket or restaurant chains that enter such agreements.

As described in more detail below for various embodiments, the bundling company 102 may then offer funds to be drawn on for payment of the food expenses to a buyer 110 or seller 111 of real property. The offered prices for the food expenses may be customary rates, at less than customary rates, and may include a transaction charge. The buyer and/or seller are sometimes referred to interchangeably herein as “consumers,” “customers,” “borrowers,” or “clients,” each of which may also refer generally to a homeowner, homebuyer, homebuilder, land developer, home seller, property owner, renter, or tenant, among others. In addition to interacting with the seller 111 and buyer 110, the bundling company 102 may interact with a number of other entities, examples of which include the food suppliers 104, appraisers 116, and one or more bundling lenders 112, who actually provide the loan.

The bundling company may maintain a customer depository account 114, where the funds to be used in making payment for the food expenses in accordance with the food-financing program are maintained, although in some embodiments the customer depository account may be maintained by a separate institution. There are a number of different ways in which funds in the customer depository account 114 may be accessed by the buyer to make payment for food expenses. A convenient mechanism includes use of a debit instrument 120 issued to the buyer that the buyer may present when making food purchases. For instance, the debit instrument could comprise a card, such as a magnetic stripe card or smart card that has information identifying the buyer 110 and the customer depository account 114 encoded on the card. Payment is then coordinated by a debit processor 118 when food purchases are made. In other instances, the buyer 110 might be provided with a set of checks that may be used to draw funds from the customer depository account 114 for food purchases. Alternatively, the buyer 110 may be permitted to make withdrawals from the customer depository account, such as in the form of coupons usable at the food suppliers 104 or to provide reimbursement for previously paid food expenses upon production of suitable receipts.

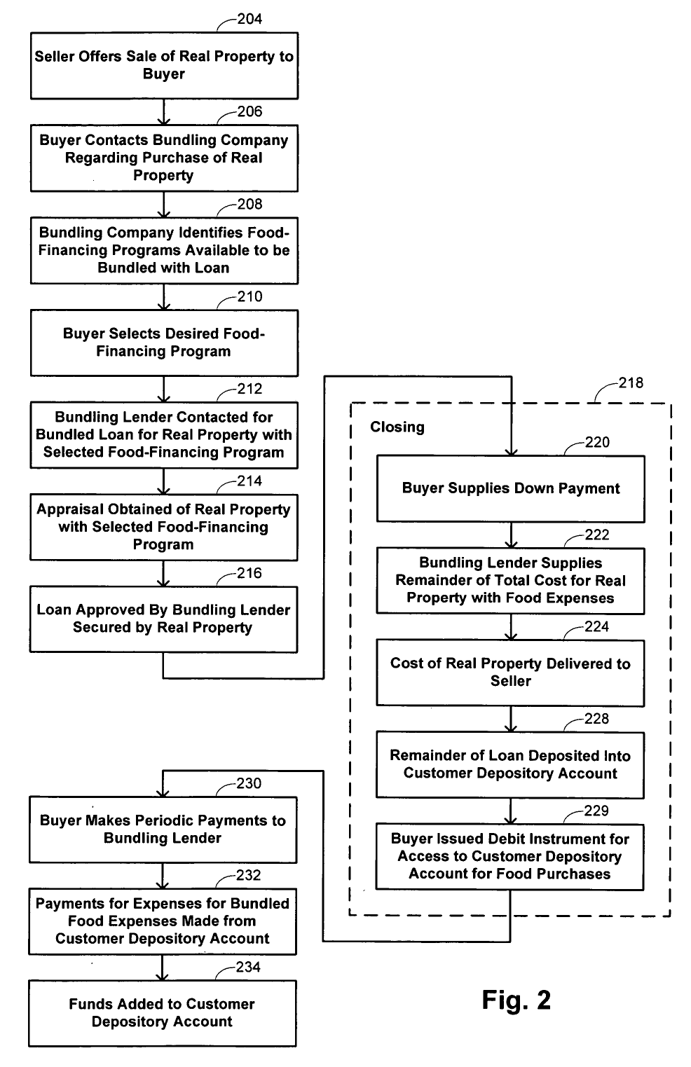

Various methods of the invention are illustrated for different embodiments with the flow diagrams of FIGS. 2-7. The method illustrated with FIG. 2 may be used in one embodiment when a seller 111 sells real property to a buyer 110. In response to the seller 111 offering the real property for sale to the buyer 110 at block 204, the buyer contacts a bundling company 102 at block 206 to coordinate funding a customer depository account 114 to support payment of the food expenses and a loan for purchasing the real property with the bundleable food expenses included. In some instances, the contact with the bundling company 102 may conveniently proceed through another third party. Also, the buyer 110 may conveniently use a variety of different sources for identifying a bundling company 102, including computer networks, the Internet, computer software tools, and other electronic media. The bundling company 102 identifies a number of food-financing programs at block 208 so that a selection of the desired program may be made by the buyer 110 at block 210. Different food-financing programs may include such features as permitting or excluding purchases of food to be consumed away from home such as at restaurants, imposing restrictions on which merchants may be used to purchase the food or offering unrestricted purchases, defining different time periods such as one year, two years, five years, and the like over which food may be purchased, etc. For instance, one program might provide two years of food purchases to be made only at grocery stores. Another program might provide five years of food purchases at any food merchant, including grocery stores and restaurants. Still another program might provide five years of food purchases at any restaurant, but with all grocery purchases to be made at a Safeway store. Still other variations are possible and other factors may be included in defining different food-financing programs. Different fees may be imposed for different programs in accordance with the level of flexibility and time commitment the buyer wishes.

At block 212, a bundling lender 212 is contacted for solicitation of a bundled loan for the real property with the selected food-financing program. The cost presented to the buyer 110 may incorporate the value of the selected food expenses into the cost or may alternatively include a separate listing of the cost for the bundleable food-financing program. In either instance, the bundling lender 112 may consider the cost or value of the selected food-financing program when qualifying the buyer 110 for the loan. In some embodiments, qualifying the buyer 110 may comprise obtaining an appraisal of the real property with the selected food expenses as indicated at block 214, but this is not necessary in other embodiments. The appraisal may be obtained by the buyer 110, by the bundling lender 112, or by a bundling company 102 in different embodiments. If the buyer 110 qualifies for the loan, it is approved by the bundling lender 112 at block 216.

In determining whether to approve the loan request, the bundling lender may calculate a “back-end ratio” as a measure of the borrower's ability to repay the loan using techniques known in the art. A high back-end ratio may disqualify a borrower from obtaining a loan. Embodiments of the invention advantageously lower the back-end ratio by eliminating certain borrower payments related to food expenses. For example, by financing the borrower's food expenses in a loan, the back-end ratio may be reduced, permitting the borrower to qualify for a larger loan amount. Lowering the back-end ratio also advantageously permits the bundling lender to modify its underwriting procedures, making the borrower's loan qualification easier. It also permits the lender to structure and offer new loan products that are based on this ability to lower the back-end ratio and other defaulting events. In particular, this capability is advantageous in structuring new loan products that may be attractive for sale in the secondary mortgage marketplace. Embodiments of the invention also advantageously expand the ability of bundling lenders to make new types of loans to new borrowers and to enter new markets by developing active partnerships with restaurants, grocery stores, and other food suppliers.

When the loan is to close, as indicated in the drawing generically by blocks 218, the buyer 210 typically supplies a down payment at block 220, although in some embodiments the loan might be provided without a down payment. The bundling lender 112 supplies the remainder of the total cost for the real property, plus the money to fund the food-financing program, as indicated at block 222. The cost of the real property is delivered to the seller 111 at block 224, and the remainder of the loan amount is deposited into the customer depository account 114 at block 228. As indicated at block 229, the buyer may also be issued a debit instrument such as a magnetic-stripe card, smart card, or other type of instrument used in identifying the customer depository account to make purchases consistent with terms of the food-financing program. In some instances, other products and services may be bundled into the loan, in addition to the cost of the food-financing program described in detail herein. A detailed description of a variety of products and services that may be bundled is provided in the parent and related applications, which have been incorporated herein by reference. When some of those other products and services are also bundled, the funds deposited in the customer depository account are earmarked for payment of both food expenses as well as expenses related to those other bundled products/services.

The customer depository account 114 may comprise any suitable account, such as a trust account, an interest-bearing account, an insurance account, or a bank account, and in some embodiments the customer depository account 114 may comprise a plurality of accounts, which may be maintained by a plurality of different institutions. In some instances, separate customer depository accounts may be provided for different classes of food expenses (e.g. for grocery-store and restaurant purchases) or a single customer depository account may be segregated for separate tracking of different classes of products. If other types of products or services are also being financed in this way, the segregation of the customer depository account or the use of multiple customer depository accounts may be used to monitor food expenses separately from other types of expenses. Once the funds have been received in the customer depository account 114, the bundled food-financing program is assigned to the sold property, rather than to the borrower, and becomes an asset of the property, thereby conferring on it the status of a real-property interest. The funds in the customer depository account 114 may thereafter be used to make payments for the bundled food expenses. The bundling lender 112 may be issued a document entitling the bundling lender 112 to foreclose on the customer depository account upon a default of the bundling loan by the borrower. The document typically identifies the funds being held in the customer depository account 114, as well as designating the funds as a “prepaid asset” of the property. The bundling lender 112 and/or buyer 110 are generally provided with the ability to obtain via telephone and/or electronic mechanisms the current cash balance in the customer depository account.

The total loan amount includes the amount of payments for the future expenses used in supporting the bundled food expenses. The future payment amount for payments on both the bundled food expenses and on the property are amortized over the term of the loan. The loan term may advantageously have a term as long as 30 years (or even as long as 40 years in the case of some real-property loans). This is in contrast to consumer loans, which usually have terms of less than five years. In addition, using a structure that has a real-property loan with a real-property interest may provide tax advantages, such as in the United States where interest on real-property loans may be tax deductible. It is noted that this benefit is a consequence of the designation of the prepaid assets as real-property interests. In the United States, Freddie Mac and Fannie Mae were chartered by Congress to provide liquidity to the mortgage banking industry and are purchasers of more than 90% of the mortgage loans that originate in the U.S. In their charter, Freddie Mac and Fannie Mae could only purchase loans from mortgage banks that are real property and that do not include personal property. This is why a stand-alone television could not be financed within a mortgage, but a home theatre could. In response to consumer demand and a request from the National Association of Realtors, Freddie Mac designated certain appliances as providing a “real-property interest,” that permits their cost to be financed with a mortgage loan.

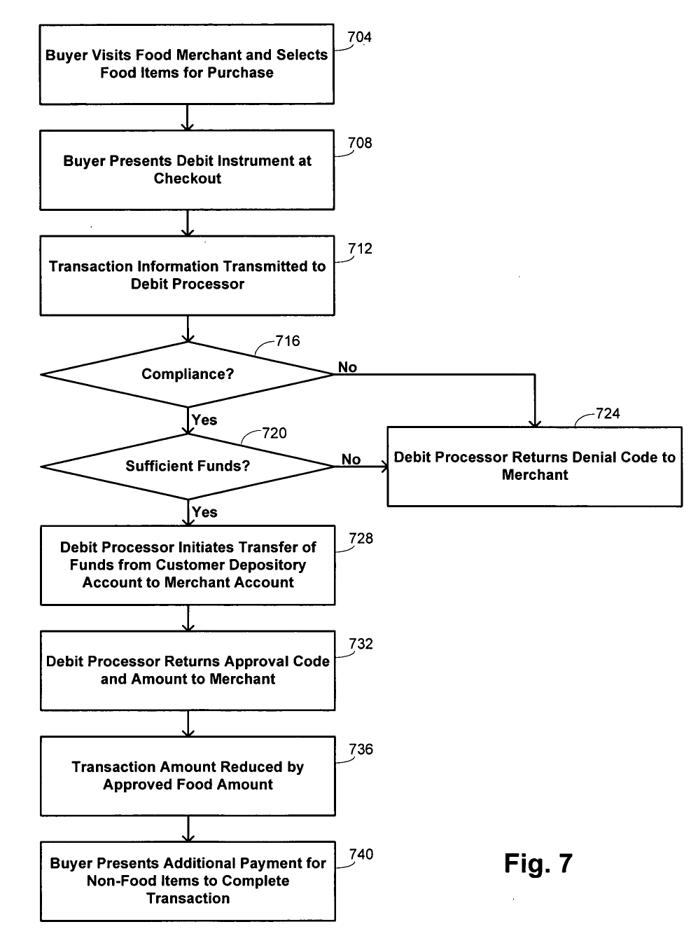

After closing, the buyer makes periodic payments to the bundling lender at block 230, similar to conventional mortgage payments. These payments may be made monthly, biweekly, or according to some other arrangement. In some embodiments, additional principal payments may also be accepted with the periodic payments to the bundling lender. The payments for the food expenses are made from the customer depository account at block 232. In embodiments where a debit instrument 120 has been provided to the buyer, such payments may be made in the form of a debit transaction at a point-of-sale, such as is described further in connection with FIG. 7 below. The duration of the useable period of the bundled food expenses may be more or less than the original term. For example, the borrower may purchase more food as a result of changes in family circumstances, resulting in more funds being withdrawn from the customer depository account 114. In this instance, the usable term of the bundled food expenses would be less than the initial term because the customer depository account will be depleted faster than initially planned. Conversely, the borrower may use purchase less food, resulting in fewer funds being withdrawn from the customer depository account. In that case, the term of the bundled food expenses is longer than the initial term because the funds in the customer depository account 114 will last longer. As indicated at block 234, funds may sometimes be added to the customer depository account to lengthen the usable term of the bundled food expenses. Funds may be added by the buyer in some embodiments, or may be added by other entities such as the bundling company 102 or by the bundling lender 112 as part of a variety of possible incentive programs. In some embodiments where separate tracking for different classes of products is provided through the use of a segregated account or through the use of a plurality of accounts, transfers between the different classes may be enabled.

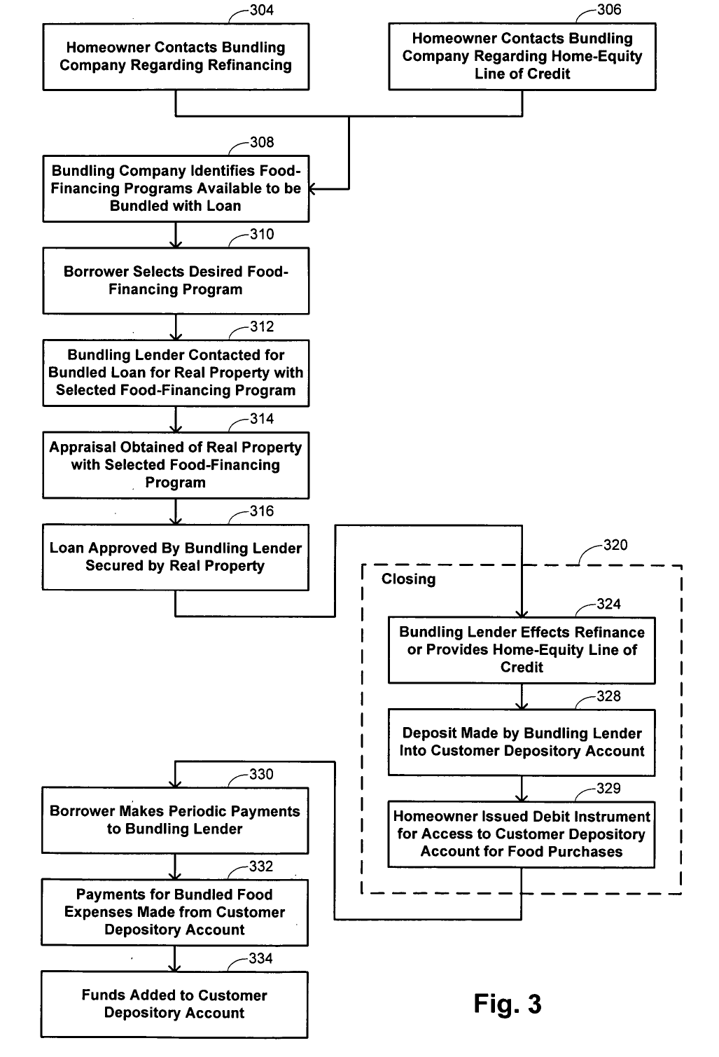

A similar method may be implemented in embodiments where an existing homeowner wishes to refinance an existing mortgage or wishes to take a home-equity line of credit secured by the real property. These embodiments are illustrated with the flow diagram of FIG. 3 and have a number of aspects in common with aspects of the invention described in connection with FIG. 2. The homeowner contacts the bundling company 102 at block 304 or block 306 depending on the embodiment, again having the ability to make use of a variety of different informational tools to identify the bundling lender and perhaps making contact through a third party. Block 304 applies to homeowners seeking to refinance existing mortgages and block 306 applies to homeowners seeking a home-equity line of credit. Home-equity lines of credit are loans in which the borrower secures the loan with real property. They provide borrowers with long-term financing at attractive interest rates when compared with consumer loans that have relatively short terms and much higher interest rates. They differ from mortgages, which are used to finance the purchase of real estate. Highly developed markets exist for both mortgages and home-equity lines of credit, with lender being compensated with interest on the principal that is lent.

In either instance, the bundling company 102 may identify a number of food-financing programs that may be bundled with the loan at block 308, the different options permitting different terms, different types of food (e.g. restaurant versus grocery store), limitations on food suppliers, etc. The borrower selects that food-financing program he wishes to include with the loan at block 310, including specification of a term for the program if appropriate. A bundling lender 112 is contacted at block 312 with a request to provide a bundled loan for the real property and the selected food-financing program. The total loan cost is determined by amortizing the cost of both the underlying loan and the cost of the selected food-financing program. An optional appraisal may be obtained at block 314, with the loan being approved by the bundling lender at block 316 if the borrower meets the loan requirements.

At closing 320, the bundling lender 112 provides the refinancing or home-equity line of credit at block 324 and deposits funds into the customer depository account 114 at block 328. The bundling lender 112 is provided at closing with a document asserting its right to foreclose against the customer depository account 114 as well as against the real property itself in the event of a default. The homeowner may be provided with a debit instrument such as a magnetic stripe card or smart card at block 329 to simplify accessing the customer depository account 114 in making food purchases. After closing, the relationship between the borrower and bundling lender is similar to that described above. The borrower makes periodic payments to the bundling lender as indicated at block 330 and payments for the food expenses are made from the customer depository account as indicated at block 332, perhaps involving presentation of the debit instrument as described below in connection with FIG. 7. Similar to the embodiments described in connection with FIG. 2, the usable term of the bundled food expenses may be longer or shorter than initially planned, depending on the rate at which the funds are used. A provision is therefore provided at block 334 to permit funds to be added to the customer depository account to extend its usable term, either by the borrower or by another entity such as the bundling company 102 or bundling lender 112 in different embodiments.

FIG. 4 provides a similar flow diagram, but reflects aspects of the invention relevant to land development by a builder. This embodiment provides an example where one of the parties to the sale transaction for real property acts as the bundling company with the builder taking on this role, although in alternative embodiments a separate bundling company may work with the builder and buyer. The builder generally provides new construction, offering the sale of real property to a buyer at block 402. Because the builder is providing new construction, the range of options that may be provided as part of the construction is diverse. Traditional fixed-cost options that may be offered include such enhancements as wood cabinetry, granite countertops, gold bathroom fixtures, upgraded carpet, and the like. In addition, the builder may in some embodiments include a food-financing program as part of the standard purchase arrangement. For instance, in one embodiment, the builder may advertise that the sale of each home includes, as standard, five years of grocery payments at Safeway and may offer options to provide certain other food costs at the option of the buyer —these may be marketed as “upgrades” and may include such things as five years of restaurant payments or permitting the grocery payments to be made to other grocery suppliers of food. The standard items are identified to the buyer at block 404 and the optional food-financing programs are identified to the buyer at block 406.

In response to the buyer making a selection of a desired food-financing program at block 408, the sale cost is updated at block 410 by amortizing the total cost of both the standard and upgrade aspects. The bundling lender 112 is contacted at block 412, either by the buyer, by the builder, or through another third party, and asked to provide terms for a loan to purchase real property with the selected food-financing program, as well as any other options that may have been selected. The bundling lender 112 performs an analysis to determine whether to approve the loan, and performing that analysis may sometimes include obtaining an appraisal of the property with the selected food-financing program at block 414. Approval of the loan by the bundling lender is indicated at block 416 and, as previously noted, may comprise calculation of a back-end ratio that accounts for the reduction in food expenses faced by the borrower as a result of their bundling with the loan.

Closing is denoted generally by blocks 418. As part of closing on the loan, the buyer may supply a down payment at block 420, although in some embodiments the loan may close without any down payment. The bundling lender 112 supplies the remainder of the cost for purchase of the real property as well as for financing the costs of the selected food expenses at block 422. The cost of the real property is delivered to the builder at block 424 and the remainder of the loan amount is deposited into the customer depository account 114 at block 428. The bundling lender 112 is also provided with documentary authority to foreclose on the customer depository account as well as on the real property in the event that the borrower defaults. In addition, in some embodiments, the buyer may be provided with a debit instrument at block 429; such a debit instrument advantageously permits food purchases to be supported directly be the customer depository account at the point of sale over existing debit networks by identifying the customer depository account 114.

After closing 418, the builder is no longer involved. The buyer makes periodic payments to the bundling lender 112 at block 430 to satisfy his obligations under the loan arrangement. Payments for food expenses are made at block 432 from the customer depository account 114, perhaps using the debit instrument provided at block 429. As previously noted for other embodiments, the length of time that the customer depository account may cover expenses may vary, depending on how much is actually spent in satisfying those expenses. In cases where the term that the account covers is less than originally expected, a mechanism may exist in some embodiments to add additional funds to the customer depository account at block 434, such as by the buyer or by another entity like the bundling company or bundling lender.

In some cases, for any of the embodiments described in connection with FIGS. 2-4, the owner of real property that secures a loan that bundles a food-financing program may wish to sell the property. The funds in the customer depository account may be treated in a number of different ways in different embodiments. For instance, in some cases, the owner may transfer the funds from the customer depository account to a subsequent buyer of the property. In other cases, the owner may transfer the funds to a new property that the owner purchases.

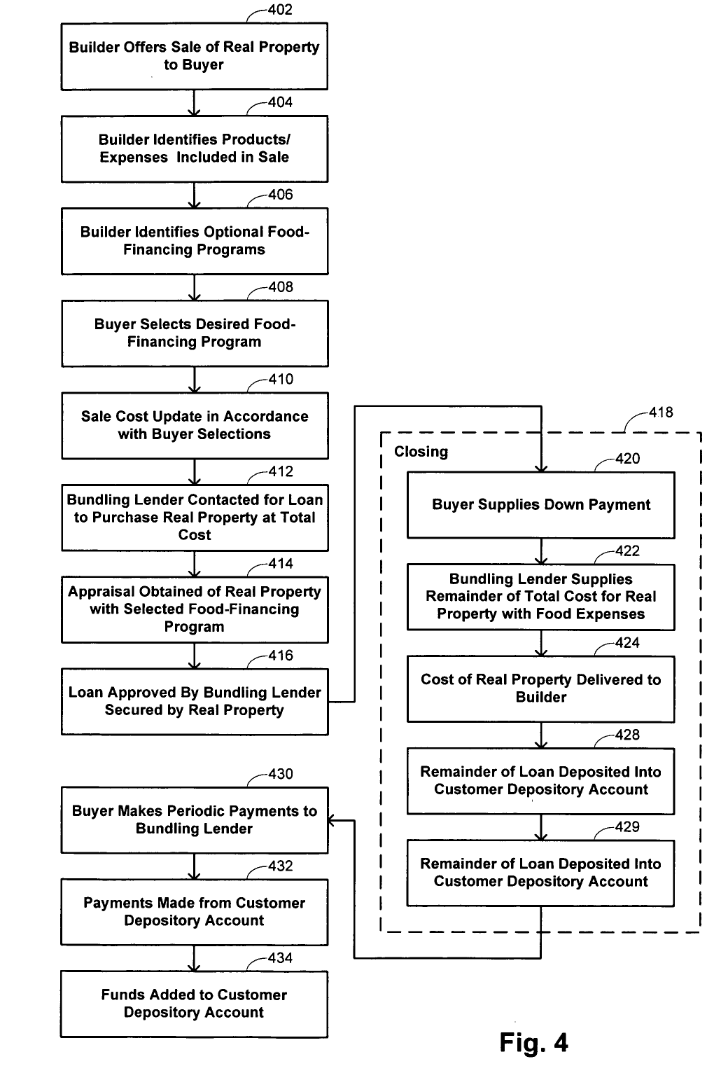

The descriptions of certain embodiments of the invention above are not intended to be exhaustive and may be accommodated within a wide range of lending products. For example, the loan may comprise any of the following in different embodiments: a first mortgage secured by the property and perhaps also by the cash value of the food-financing program; a second mortgage secured by the property and perhaps also by the cash value of the food-financing program; a third mortgage secured by the property and perhaps also by the cash value of the food-financing program; a refinanced mortgage secured by the property and perhaps also by the cash value of the food-financing program; a home-equity loan secured by equity in the real property and perhaps also by the cash value of the food-financing program; a home-equity line of credit secured by equity in the real property and perhaps also by the cash value of the food-financing program; a construction loan secured by the real property and perhaps also by the cash value of the food-financing program; and a personal note secured by the real property and perhaps also by the cash value of the food-financing program. In some instances, a plurality of loans may be used to finance the food expenses, such as when they are financed through a first and second mortgage. Each of the descriptions of FIGS. 2-4 above have noted that in some instances an appraisal may be sought, such as part of the loan-qualification process. An overview of methods that may be used to perform an appraisal in provided with the flow diagram of FIG. 5. This method illustrates how the effect of bundling food costs with the loan may be accommodated as part of the appraisal. It is noted that in some embodiments the real property that is the subject of the appraisal may already have a customer depository account associated with it and classified as a prepaid asset of the property. This is true, for instance, in some embodiments described in connection with FIG. 2 where an existing home might be sold to a new owner. Such a pre-existing customer depository account may be used for payment of food expenses or could be used for payment of other types of expenses like those described in detail in the related and parent applications.

At block 504 of FIG. 5, an appraiser 116 receives an order for an appraisal, usually from a bundling lender or from a borrower, although in some instances the request for an appraisal may be transmitted from the bundling company or through some third party. The appraiser 116 collects information on the remaining value of products and/or services, including a food-financing program supported by a customer depository account associated with the property, as indicated at block 512. This value acts to increase the base value of the property. These products and/or services are termed “seller products/services” because they represent a prepaid asset of the seller's property and are distinct from the “buyer products/services” that the buyer wishes to bundle. In embodiments where the seller has no customer depository account to draw on, such as where the seller is a builder or where the seller arranged a loan without such a structure, the base value is equal to the value only of the real property. At block 512, the appraiser compares the fair market value of the property with the buyer products/services included with its value without the buyer products/services but including the seller products/services, if any. The difference between the two is assigned as a valuation difference to the property. In most instances, it is expected that the valuation difference will be a valuation increase, such as when there are no seller products/services or when the value of the seller's customer depository account has been depleted through prior payments. The property is accordingly appraised to include the value of the buyer products/services at block 516 and the appraisal is transmitted to the lender or borrower at block 520.

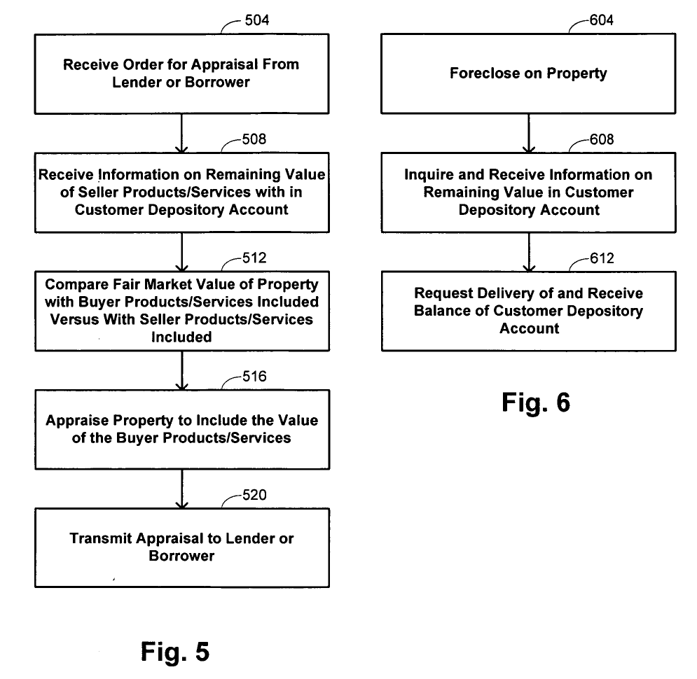

Because of the nature of the classification of funds held within the customer depository account as a prepaid asset of the property, that value is subject to foreclosure in the event of a default on the loan provided by the bundling lender. The authority for the bundling lender to foreclose against the funds held within the customer depository account may be provided with a document showing the classification of the funds as a prepaid asset. FIG. 6 provides a flow diagram illustrating the effect of foreclosure according to an embodiment of the invention. At block 604, the bundling lender 112 forecloses on the real property itself in a conventional manner. In addition, as indicated at block 608, the bundling lender 112 may receive information setting forth the remaining value in the customer depository account 114, thereby enabling the bundling lender 112 to request delivery of and receive the balance of the account at block 612. In some embodiments, the bundling lender 112 may alternatively provide instructions for the funds in the customer depository account to be assigned to a new designated real property or to a new buyer of the current designated property or to a supplier.

An illustration of how funds in the customer depository account 114 may be accessed for purchases of food is provided with the flow diagram of FIG. 7. Briefly, the funds are accessed by presentation of the debit instrument at the point-of-sale, with information from the debit instrument being used to identify the customer depository account 114 and initiate a transfer of funds from that account to an account controlled by the merchant selling the food.

Thus, at block 704, a buyer who possesses a debit instrument that identifies a customer depository account 114 visits a food merchant and selects food items for purchase. The food merchant may be a seller of food that is normally consumed at home, such as when the merchant comprises a grocery store, or may be a seller of food that is normally consumed away from home, such as when the merchant comprises a restaurant. Selection of food items may thus amount to picking individual items off shelves or placing an order with a waiter in different embodiments. In some instances, a surrogate for such activities may be involved, such as when the buyer orders groceries for delivery from a grocery delivery service by telephone or over the Internet, or when the buyer orders cooked food for delivery from a delivery restaurant. Also, in some instances, the selection of food items may also comprise selection of nonfood items, such as when a merchant sells both food and nonfood items.

When the buyer is ready to complete the purchase, he presents his debit instrument at block 708. This may involve presenting the instrument to a clerk at a grocery store, to a waiter at a restaurant, or the like. The debit instrument may conveniently comprise a magnetic-stripe card or smart card in some embodiments. A point-of-sale device at the merchant extracts information from the debit instrument, such as by reading the magnetic stripe of a magnetic-stripe card or by reading a chip embedded in a smart card. This information may identify the buyer and the customer depository account 114 and is combined with other transaction information specifying a price of the purchase and forwarded to the debit processor 118 at block 712.

The information received by the debit processor 118 may be used to ensure compliance with terms of the applicable food-financing program at block 716. For example, the buyer identification included as part of the transaction information may be used to identify whether there are restrictions on what type of food may be purchased and where it may be purchased according to the program. If the transaction is not in compliance, a return code may be returned to the merchant to refuse the transaction at block 724. For example, if the food-financing program limited food purchases to grocery purchases and the buyer was attempting to make a restaurant purchase, the debit processor 118 would identify the inconsistency from an identification of the merchant in the transaction information and initiate a return of the denial code. A similar action would be taken if the food-financing program limited food purchases to particular merchants and the food merchant visited at block 704 was not one of those merchants.

An additional aspect of determining compliance at block 716 may involve identifying a portion of the transaction as eligible for application to the customer depository account 114, such as when the buyer selects both food and nonfood items. The food items may be segregated, and the cost for that portion of the transaction determined, from information that identifies the products individually. For instance, if the products are identified with bar codes that are scanned by the point-of-sale device, the individual products may be identified using the Universal Product Code (“UPC”) system, the European Article Number (“EAN”) system, the Global Trade Item Number (“GTIN”) system, the Serialized Shipping Container Code (“SSCC”) system, the Global Location Number (“GLN”) system, the Global Returnable Asset Identifier (“GRAI”) system, the Global Individual Asset Identifier (“GIAI”) system, and the Global Service Relation Number (“GSRN”) system, among others. Many of these systems are currently administered by the Uniform Code Council, Inc. (“UCC”) and EAN International. While the emphasis of the these organizations is currently on bar-code technologies, including Reduced Space Symbology (“RSS”) and Composite Symbology (“CS”), they acknowledge that the systems may alternatively be implemented using other technologies, such as with radio-frequency tags. Embodiments of the invention are not restricted to any particular classification technology and are intended to encompass all such classification systems.

Also, the ability of the debit processor 120 to analyze the transaction information further permits the use of other types of debit instruments, including even biometrics that identify the buyer. For example, instead of presenting a magnetic-stripe card or smart card as a debit instrument, in some embodiments the buyer may allow his fingerprint, iris, or retina to be scanned, or to have his hand or facial geometry analyzed. This information is then bundled with the transaction information and analyzed by the debit processor 120 to identify the individual from stored biometric records and thereby determine any restrictions that apply to the corresponding food-financing program and identify the customer depository account 114.

Once full or partial compliance with the food-financing program has been verified, the debit processor 120 may query the customer depository account 114 to confirm that sufficient funds remain in the account to pay for the food items. If not, the debit processor 120 returns a denial code at block 724 so that the merchant may refuse the transaction. If there are sufficient funds, the debit processor 120 initiates a transfer at block 728 of the funds to be used in paying for the selected food items from the customer depository account 114 to an account controlled by the merchant. An approval code is returned to the point-of-sale device at block 732 to confirm that the transfer has been executed and that the merchant should proceed with the sale of the food items to the buyer. In cases where the transaction involves the purchase of both food and nonfood items, the approval code may be accompanied with a specification of the amount that was transferred between accounts so that the transaction amount due for the nonfood items may be reduced at block 736 by the amount approved for food payment. The buyer presents additional payment for the nonfood items at block 740, thereby completing the transaction. The additional payment may take the form of any payment accepted by the merchant, such as cash, a check, a credit card, a debit card to a different account, and the like.

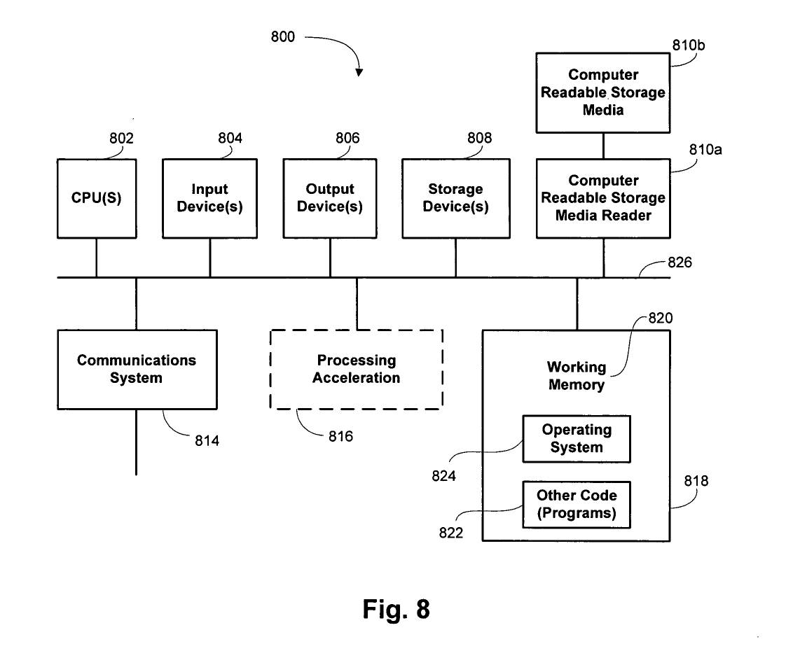

In many embodiments, the methods described in connection with FIGS. 2-7 may be coordinated by computational devices that provide connectivity as shown with the schematic drawing of FIG. 1. A typical structure for such computational devices is shown in FIG. 8, which broadly illustrates how individual system elements may be implemented in a separated or more integrated manner. The computational system 800 is shown comprised of hardware elements that are electrically coupled via bus 826, including a host processor 802, an input device 804, an output device 806, a storage device 808, a computer-readable storage media reader 810a, a communications system 814, a processing acceleration unit 816 such as a DSP or special-purpose processor, and a memory 818. The computer-readable storage media reader 810a is further connected to a computer-readable storage medium 810b, the combination comprehensively representing remote, local, fixed, and/or removable storage devices plus storage media for temporarily and/or more permanently containing computer-readable information. The communications system 814 may comprise a wired, wireless, modem, and/or other type of interfacing connection and permits data to be exchanged with the other computational devices such as illustrated by the schematic arrangement of FIG. 1 to implement embodiments as described.

The computational device 800 also comprises software elements, shown as being currently located within working memory 820, including an operating system 824 and other code 822, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

### EXAMPLES

Certain benefits and advantages of embodiments of the invention are evident from the following description of specific examples.

### Example No. 1

In a first example, a consumer wishes to increase monthly cashflow by lowering monthly cash expenses. As part of a refinancing of the consumer's home mortgage to reduce the payment by taking advantage of a reduction in interest rates, the customer bundles food expenses for a family having a retail monthly price of $500.00. By using a mortgage loan amortized over 30 years, the monthly cash expense for food is reduced to about $145.00.

### Example No. 2

In a second example, a prospective homeowner anticipates paying an average of about $500 per month for groceries, in addition to about $200 per month for restaurants, for total monthly food expenses of $700. Over five years, the prospective homeowner thus expects to pay about $42,000 for these food expenses. The prospective homeowner decides to purchase a home having a base appraised value of $300,000 and to bundle these costs with the mortgage. The total appraised value is the sum of the base appraised value of the home and the five years of food expenses for a total of $342,000. The homeowner closes by making a 20% down payment on a 6%-interest loan, providing a mortgage amount of $273,600. The borrower's mortgage payment is thus $1640/month. If the borrower had taken a loan only on the real property for 80% of the $300,000, his mortgage payment would have been $1439/month. While the increase in the loan payment is $201/month, the monthly expenses of $700 have been eliminated since they are paid from an associated customer depository account, providing the homeowner with an increased monthly cashflow increase of about $500.

This advantage may be exploited further by noting that the mortgage interest is tax deductible in the United States. Using a 30% combined state and federal tax rate, the “after tax” value of the $201/month difference in payments is effectively $141, providing the homeowner with $559/month in increased average cashflow.

### Example No. 3

In a third example, the same scenario as presented in Example No. 2 is repeated, with the homeowner this time investing the additional cashflow in an interest-bearing account at a 5%/year interest rate. At the end of the 60 months of paid services, the savings accumulation would be $42,484. This corresponds to an average monthly increase in cash flow of $708, more than the cost of the food being financed. While the effective cost of the services averaged over 60 months might be $800/month because of increases in food costs, the average cost to the homeowner is fixed in accordance with the invention at a negotiated rate of $700. Since the average increase by investing the savings exceeds this fixed cost, the homeowner has effectively received the food for free.

The homeowner is also insulated from price volatility of food costs. This is beneficial not only to the homeowner, but also to the lender who is insulated from circumstances that not uncommonly result in mortgage defaults.

### Example No. 4

In a fourth example, the same scenario as presented in Example No. 3 is repeated, with the homeowner deciding to pay off the mortgage at the end of the five-year period. The mortgage balance is $254,597, which may be compared with a balance of $223,330 that would have resulted if the borrower had financed only the real property at $300,000. The difference in pay-off amounts is $31,267, which is more than offset by the accumulated savings of $42,484, the homeowner being $11,217 ahead of a conventional arrangement.

### Example No. 5

In a fifth example, the same scenario as presented in Example No. 3 is repeated, with the homeowner deciding to renew the arrangement and purchase another five-year term of food expenses. This can be done in at least three different ways: (1) by refinancing the home and including another five-year term of bundled food expenses; (2) by keeping the first mortgage and obtaining a home-equity line of credit to pay for and bundle the food expenses; or (3) by paying retail for the food expenses. If the homeowner chooses the first option, the accumulated savings at the end of 30 years would be approximately $527,976, with a net savings after paying off the mortgage differential of $307,397. If the homeowner chooses the second option, the overall accumulated savings at the end of 30 years would be approximately $402,746, with a net savings of $163,1735. If the homeowner chooses the third option, the overall accumulated savings at the end of 30 years would by $47,307, with a net savings of $47,307.

### Example No. 6

In a sixth example, a bundling lender simultaneously originates a first mortgage loan and a second mortgage loan. The cost of the bundled food expenses are included in the second mortgage loan. This permits the buyer of the real property to acquire both it and the bundled food expenses for “no money down.” For example, the first mortgage may be an 80% loan-to-value loan, leaving 20% equity available for the second mortgage. For a property having an appraised value of $300,000, including $50,000 of bundled food expenses, the 80% loan is for $280,000 and the second mortgage is for $70,000. At the loan closings, the second mortgage loan funds the customer depository account in the amount of $50,000 for satisfying the food expenses. The borrower benefits by not having to use any cash to purchase the property and the bundled food expenses, as well as by avoiding the mortgage-insurance requirement attached to loans of 90% loan-to-value or greater. The bundling lender considers the cost of the bundled food expenses in qualifying the borrower for two loans, one being a bundled loan, and may order an appraisal and identify the bundled food expenses with the property. Once the borrower qualifies for the bundled loan, the bundling lender commits the funds for payment of the food expenses and distributes the funds in accordance with a predetermined agreement as described above.

### Example No. 7

In a seventh example, a homeowner decides to sell his present home with a balance remaining in the customer depository account. The homeowner transfers the remaining funds in the customer depository account to the new purchaser of the existing property.

### Example No. 8

In an eighth example, a homeowner decides to sell his present home with a balance remaining in the customer depository account. The homeowner transfers the remaining funds in the customer depository account to the new, second property.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A method for providing a loan to a borrower, the method comprising:
receiving, at a host system, an identification of real property and a specification of a monetary amount to be used for future payment of food expenses;
calculating, with the host system, a total loan value for the real property and specified monetary amount;
requesting, with the host system, approval of the loan secured by the real property for the total loan value; and
initiating, with the host system, a closing on the loan at which a customer depository account is funded with the specified monetary amount to provide future funds for payment of food expenses incurred by the borrower.

2. The method recited in claim 1 further comprising:
receiving, with the host system, a set of limitations defining food expenses that qualify for payment with funds in the customer depository account; and
initiating, with the host system, restrictions on withdrawal of funds from the customer depository account in accordance with the set of limitations.

3. The method recited in claim 2 wherein the set of limitations defines one or more specific merchants at which food must be purchased to qualify for payment with funds in the customer depository account.

4. The method recited in claim 2 wherein the set of limitations defines that only food purchased from merchants selling food for normal consumption at home qualifies for payment with funds in the customer depository account.

5. The method recited in claim 1 further comprising initiating, with the host system, issuance of a debit instrument to the customer that may be used at a point of sale to debit the customer depository account as part of a debit transaction for payment of the food expenses.

6. The method recited in claim 5 wherein the debit instrument is selected from the group consisting of a magnetic-stripe card and a smart card.

7. The method recited in claim 1 wherein the loan is also secured by funds in the customer depository account.

8. The method recited in claim 1 further comprising:
receiving a specification of products and/or services distinct from the monetary amount to be used for future payment of food expenses,
wherein:
calculating the total loan value comprises calculating the total loan value for the real property, the specified monetary amount, and the specified products and/or services distinct from the specified monetary amount; and
the customer depository account is funded with the specified monetary amount and a supplementary monetary amount for payment of expenses for the specified products and/or services.

9. The method recited in claim 8 wherein the customer depository account comprises a plurality of customer depository accounts, each of the plurality of customer depository accounts being identified with a distinct subset of the products and/or services and the monetary amount to be used for future payment of food expenses, the method further comprising effecting a transfer of funds among at least some of the plurality of customer depository accounts.

10. The method recited in claim 8 wherein the customer depository account is segregated for separate tracking of funds identified with distinct subsets of the products and/or services and the monetary amount to be used for future payment of food expenses, the method further comprising changing an identification of the funds among the distinct subsets.

11. A method for providing a loan to a borrower, the method comprising:
receiving, at a host system, an identification of real property and a specification of products and/or services providing expenses;
calculating, with the host system, a total loan value for the real property and specified products and/or services;
requesting, with the host system, approval of the loan secured by the real property for the total loan value;
initiating, with the host system, a closing on the loan at which a customer depository account is funded to provide future funds for payment of the expenses; and
initiating, with the host system, issuance of a debit instrument to the customer that may be used at a point of sale to debit the customer depository account for payment of the expenses.

12. The method recited in claim 11 wherein the loan is also secured by the specified products and/or services.

13. The method recited in claim 11 further comprising designating funds in the customer depository account as a prepaid asset linked with the real property, whereby the funds in the customer depository account comprise a real-property interest.

14. The method recited in claim 11 further comprising initiating foreclosure against the real property and against the customer depository account in response to a default by the borrower on terms of the loan.

15. The method recited in claim 11 further comprising initiating payment of a guarantee amount defined by a remaining value of the products and/or services to a lender of the total loan value in response to a default by the borrower on terms of the loan.

16. The method recited in claim 11 further comprising initiating a transfer of ownership of the real property and a transfer of obligations under the loan to a guarantor in response to a default by the borrower on terms of the loan.

17. The method recited in claim 11 further comprising initiating a transfer of the customer depository account to a new buyer of the real property.

18. The method recited in claim 11 further comprising initiating a transfer of the customer depository account to a new property purchased by a current owner of the real property after a sale of the real property.

19. The method recited in claim 11 further comprising increasing a value of the customer depository account by depositing additional funds after closing into the customer depository account, whereby a useable term of the customer depository account for payment of the expenses is extended.

20. The method recited in claim 11 wherein the customer depository account comprises a plurality of customer depository accounts, each of the plurality of customer depository accounts being identified with a distinct subset of the products and/or services, the method further comprising effecting a transfer of funds among at least some of the plurality of customer depository accounts.

21. The method recited in claim 11 wherein the customer depository account is segregated for separate tracking of funds identified with distinct subsets of the products and/or services, the method further comprising changing an identification of the funds among the distinct subsets.

22. The method recited in claim 11 wherein the products and/or services comprise medical and/or healthcare services.

23. A method for providing a loan to a borrower, the method comprising:
receiving, at a host system, an identification of real property and a specification of medical and/or healthcare services;
calculating, with the host system, a total loan value for the real property and specified medical and/or healthcare services;
requesting, with the host system, approval of the loan secured by the real property for the total loan value;
initiating, with the host system, a closing on the loan at which a customer depository account is funded to provide future funds for payment of expenses for the medical and/or healthcare services; and
initiating, with the host system, issuance of a debit instrument to the customer that may be used to debit the customer depository account for payment of the medical and/or healthcare expenses.

24. A computer-readable medium having a computer-readable program embodied therein for directing operation of a computer system for a bundling company, the computer system including a communications system, a processor, and a storage device, wherein the computer-readable program includes instructions for operating the computer system to provide a loan to a borrower in accordance with the following:
receiving an identification of real property and a specification of a monetary amount to be used for future payment of food expenses;
calculating a total loan value for the real property and specified monetary amount;
requesting approval of the loan secured by the real property for the total loan value; and
initiating a closing on the loan at which a customer depository account is funded with the specified monetary amount to provide future funds for payment of food expenses incurred by the borrower.

25. A computer-readable medium having a computer-readable program embodied therein for directing operation of a computer system for a bundling company, the computer system including a communications system, a processor, and a storage device, wherein the computer-readable program includes instructions for operating the computer system to provide a loan to a borrower in accordance with the following:
receiving an identification of real property and a specification of products and/or services providing expenses;
calculating a total loan value for the real property and specified products and/or services;
requesting approval of the loan secured by the real property for the total loan value;
initiating a closing on the loan at which a customer depository account is funded to provide future funds for payment of the expenses; and
initiating issuance of a debit instrument to the customer that may be used at a point of sale to debit the customer depository account for payment of the expenses.
